(19) United States
(12) Patent Application Publication
(10) Pub. No.: US 2003/0009398 A1
(43) Pub. Date: Jan. 9, 2003

(54) Computer system for goods management in a stock company

(76) Inventors: Kuang-Shin Lin, Taipei (TW); Jeff Song, Taipei (TW); Xiao-Bo Liu, Tianjin (CN)

Correspondence Address: BIRCH STEWART KOLASCH & BIRCH, PO BOX 747, FALLS CHURCH, VA, 22040-0747, US

(21) Appl. No.: 10/170,571

(22) Filed: Jun. 14, 2002

(30) Foreign Application Priority Data
Jul. 3, 2001 (TW) 90116205

(51) Int. Cl. G06F 17/60

(52) U.S. Cl. 705/28

(57) ABSTRACT

A computerized stock management system utilizes a client and sever database architecture and includes at least a customer management unit for recording customer information; a receiving management unit, connected to the customer management unit, for processing receiving notices of the customer; a distribution management unit, connected to the customer management unit, for processing distribution notices of the customer; a stock management unit, connected to the receiving and distribution management systems, for providing storage and location management for goods; and a reworking management unit, connected to the stock management unit, for managing product packaging, amending or reconstruction and forming new products according to the customer's requirements. The invention also provides a location management method for managing goods stock through a computer.

### BACKGROUND OF THE INVENTION

1. Field of the Invention

The invention generally relates to a computer system and method for an enterprise, and more particularly relates to a computer system and method for goods management in a stock company.

2. Related Art

In conventional goods management systems, stock plays the role of goods storage and handling. With the changing needs of customers, a large amount of complicated data and the pressure of market competition, the requirements of small quantity but different kinds of products makes the goods handling more rapid and complicated. Therefore, the functions of dynamic management take the place of conventional simple storage and handling. Dynamic control integrates the conventional goods management system with newly developing data warehousing so as to manage the source, the destination and the flow of goods effectively by properly locating and managing the goods, and achieving dynamic management.

Computerized management is a necessary tool for current enterprises to improve their competitive capabilities. With computer systems, a stock company can manage orders, deliveries and stock in an effective manner, and can improve the quality and efficiency of business. Data collection and summary are also prompt and accurate. There is a great demand for warehousing enterprises to have a computer system applicable to various kinds of businesses.

### SUMMARY OF THE INVENTION

The object of the invention is therefore to provide a computer system for enterprise management, in which resources of different parts can be effectively integrated.

To achieve the aforesaid object, a computerized stock management system according to the invention utilizes a client and sever database architecture and includes at least a customer management unit for recording customer information; a receiving management unit, connected to the customer management unit, for processing receiving notices of the customer; a distribution management unit, connected to the customer management unit, for processing distribution notices of the customer; a stock management unit, connected to the receiving and distribution management systems, for providing storage and location management for goods; and a reworking management unit, connected to the stock management unit, for managing product packaging, amending or reconstruction and forming new products according to the customer's requirements.

The invention further provides a location management method for managing stock through a computer. The process includes at least the following steps. First, establish customer information in a database. Then, receive goods from a transportation company according to a receiving notice, generate a location suggestion according to the conditions of current storage, and produce a goods checklist for checking and locating the cargo. Record the result of checking and the actual storage location into the computer. After a purchase order is received, provide a distribution notice and a delivery plan. Pick and deliver goods according to the delivery plan. Finally, record the result of picking and delivery into the computer.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a schematic block diagram of a stock management system according to the invention;

FIG. 2 is a flowchart of receiving in an embodiment of the invention;

FIG. 3A is a flowchart of providing a distribution notice in an embodiment of the invention;

FIG. 3B is a flowchart of planning, picking and delivering distribution in an embodiment of the invention;

FIG. 4 is a schematic block diagram of a stock management unit in a system of the invention;

FIG. 5 is a flowchart of the storage process in an embodiment of the invention;

FIG. 6 is a flowchart of inventory checking in an embodiment of the invention;

FIG. 7 is a flowchart of reworking management according to the invention;

FIG. 8 is a summary flowchart of stock management according the invention; and

FIG. 9 is an example of a computer graphic interface in an embodiment of the invention.

### DETAILED DESCRIPTION OF THE INVENTION

The invention integrates management systems, such as customer management, receiving management, distribution management, stock management, reworking management, return goods management, cost management, vehicle management, employee performance management and system maintenance, for a logistics company. It uses a database of client and server architecture, communicating through networks of Intranet and Internet, operating via web pages, and is expandable for the development of an enterprise.

The major business of a logistics company includes: storing a customer's goods; receiving the customer's order for delivering goods to customers; and providing information and reports, such as an inventory list, product hierarchy list, etc., according to the customer's request, for monitoring and summary purposes of the customer.

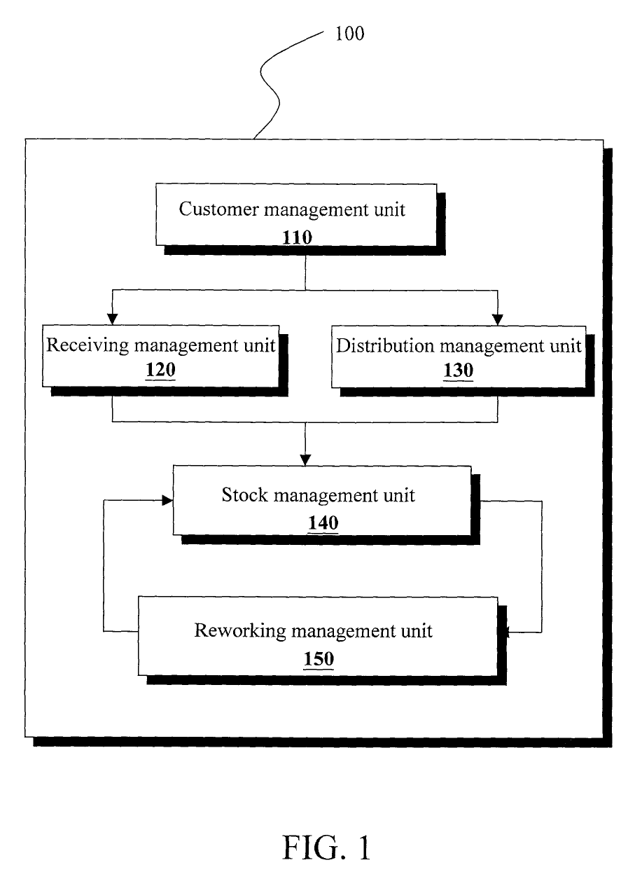

A schematic block diagram of the invention is shown in FIG. 1. The computerized management system 100 according to the invention includes a customer management unit 110 for recording customer information. The information mainly includes the customer's basic information, customer contract and credit information of the customer. Product information of the customer, such as product hierarchy list, suppliers of the customer and delivery points of the customer, is also established.

A receiving management unit 120, connected to the customer management unit 110, is used for processing receiving notices of the customer and managing proposed goods locations during the receiving process.

A distribution management unit 130, connected to the customer management unit 110, is used for processing distribution notices of the customer, generating an automatic or manual delivery plan, picking goods, verifying vehicular delivery, and registering the return sheet.

A stock management unit 140, connected to the receiving and distribution management systems 120, 130, is used for providing storage and location management for goods. The location of goods is designated by a specific location in a specific zone. According to the frequency and quantity of goods moving in and moving out, the stock is categorized into several storage zones. Each storage zone contains a plurality of storage locations. Each storage location is the basic unit of stock management, in which only one goods of the same batch and same kind can be stored. The maximum quantity of a specific goods that can be stored is calculated by the volume of the storage location and the volume of the goods.

A reworking management unit 150, connected to the warehouse management unit 140, is used for managing product packaging, amending or reconstruction and forming new products according to the customer's requirements. The aforesaid components provide ordinary functions of the stock company. The functioning processes of these components will be described as follows.

Receiving Management Unit 120

In accordance with a daily inventory report provided by the Logistics Company, a customer can supplement goods that are short of stock by informing the logistics company the schedule, items and quantities through a receiving notice. According to the condition of stock in the Logistics Company, a location suggestion for the receiving goods and a checklist of the goods are generated. Warehouse personnel check the goods and complete storage according to the checklist and location suggestions. Finally, the result of checking and the actual storage location are registered into the computer.

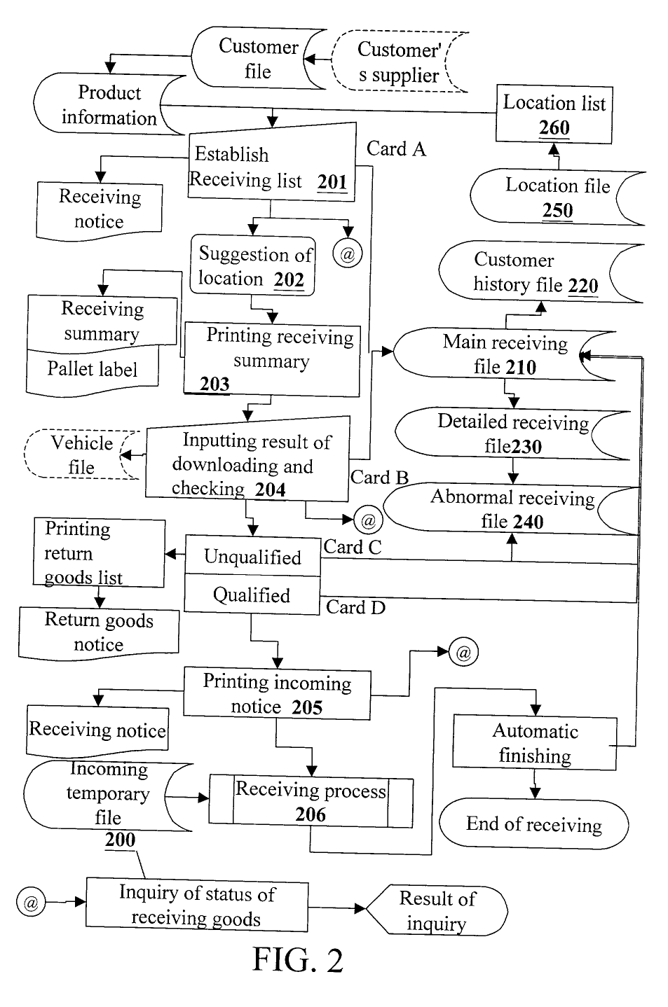

FIG. 2 shows the processing of receiving in an embodiment of the invention. In step @ (block 200), the status of the receiving goods is provided for inquiry, and the result is displayed. The detailed process is as follows. First, establish a receiving notice (step 201) with a card category (such as “A”). The receiving notice records goods codes and quantities, which can be displayed when referring to customer information and product information by the inquiry of step @. The system will generate a location suggestion for the receiving by considering empty positions of the stock, the quantity that can be stored and the receiving quantity. A receiving summary is then printed out (step 203). The receiving summary includes a receiving list and pallet numbers. The result of downloading and checking the receiving goods is inputted (step 204), and a vehicular delivery plan with a card category, for example “B”, is generated. The status of goods can be checked at this time in step @. Unqualified and qualified goods are distinguished after checking. Unqualified goods are listed in a return list with a card category, for example “C”, and a return notice for the goods provider. Qualified goods are listed in a receiving stock notice with a card category, for example “D” (step 205). The receiving stock notice is registered into a temporary receiving stock. The status of goods can further be checked at this time in step @. The temporary receiving stock is then verified (step 206), and the receiving process is automatically finished (step 207).

Through the aforesaid process, the main file of receiving, detailed list of receiving, abnormality of receiving, order history of the provider, message and processing results, abnormal situations during the receiving process and the reasons are all recorded.

Distribution Management Unit 130

The distribution process is a major activity of a logistics company, through which most of its profits are generated. Therefore, a systematic mechanism for managing distribution is a key function of a logistics system. Information of distribution can be obtained by transference from purchase order or by registration. When there is a computer management system operated at the customer site, the purchase order can be transferred to the logistics system of the invention via a document or data communication. For those customers using paper documents, the purchase order is registered to this system through a registration process. While transferring the purchase order, the system will check the stock quantity and the product information, such as its manufacturing date. If the quantity and information meet the requirements of the purchase order, the product or material stored at the specific location will be locked. After the purchase order is transferred or registered, a distribution list or a shortage list is generated to show the required quantity, available quantity and shortage quantity. Then, a vehicular delivery plan including the delivering items, quantity, destination and estimated arrival time is made according to the purchase order. The vehicular delivery plan is based on calculation of volume and weight of the product, destination and time requirements, carriage volume, capacity and freight of the vehicle, etc., and formulated to achieve an optimal combination at the lowest possible cost.

The automatic vehicular delivery plan can be manually adjusted. A picking list is generated for each vehicle according to the delivery plan. Several purchase orders can be carried out by one vehicle, so a same product for different purchase orders can be collated into a picking list to make an optimal vehicular route. After picking the goods, the result of picking is inputted into the computer system by stock personnel after verifying the picking list. This is a simple process. If the picking is the same as the picking list, verification simply involves confirming the list. Otherwise, verification requires modifying the picking list and registering the variance in the system.

The stock personnel pass the picked goods to the vehicle driver. The vehicle driver checks the goods and destination according to the picking list, and verifies the quantity. After loading, a distribution vehicle note is registered in the system. A copy of the distribution vehicle note will be left for passing through the gate. After delivery, a copy of the delivery list signed by the recipient will be returned to the stock personnel for registering the delivery result in the system. For those goods refused by the customer, the system will generate a receiving list of abnormal goods, and provide a suggestion for storage location when returning the goods to the stock. The stock personnel check the abnormal goods and store them in place. In accordance with the customer's requirements, the logistics company will provide forms, such as a summary of receiving and distribution products, monthly and daily income reports, daily stock reports and product hierarchy lists of the customer. These forms help customers monitor and manage their goods in the Logistics Company.

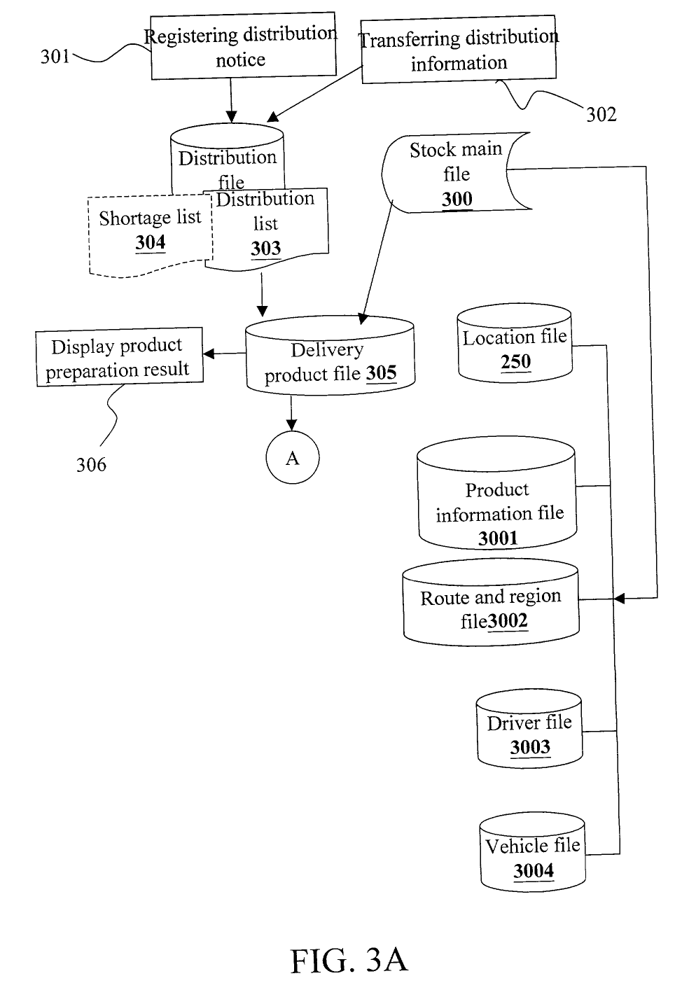

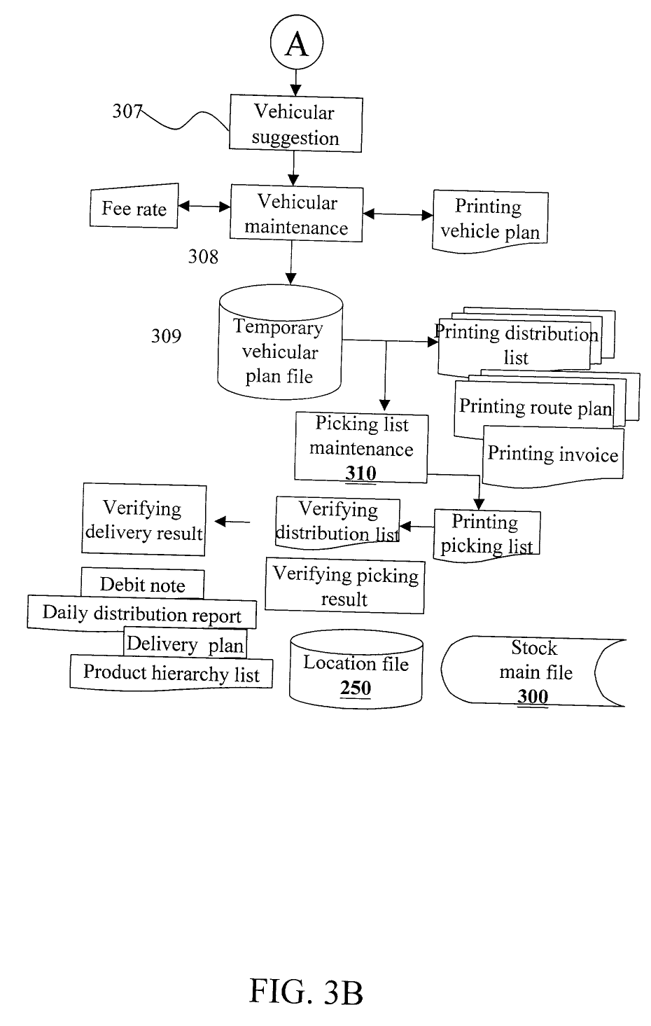

FIG. 3A is a flowchart of providing a distribution material notice in an embodiment of the invention. By registering a distribution notice (step 301) or transferring distribution information (step 302) to a distribution file, a distribution list (step 303) or a shortage list (step 304) is generated to show the required distribution quantity, available quantity and shortage quantity of the product. After registration or transference, a purchases order with the product available or allowed with shortage is turned into a delivery product file (step 305), and a product preparation result is displayed (step 306). The process of providing a distribution notice is finished. Then, the process of producing the vehicular plan, picking and delivering goods can be done. This process requires the information of a stock main file 300, a location file 250, a product information file 3001, a route and region file 3002, a driver file 3003 and a vehicle file 3004.

FIG. 3B is a flowchart of planning, picking and delivering goods in an embodiment of the invention. In accordance with the aforesaid distribution product file, the system produces a vehicular suggestion (step 307). The vehicular suggestion can be modified manually (step 308). By considering the fee rate, a vehicle plan can be printed. The system then registers the vehicle plan to a temporary vehicular plan file (step 309) for further printings of distribution lists, picking lists, route plans and invoices, and for verification and modification of picking lists (step 310). The result is then stored into the stock main file 300 and the location file 250. After product delivery, according to the return sheet of reception, the debit note, daily distribution report, delivery plan and the product hierarchy list are updated.

Stock Management Unit 140

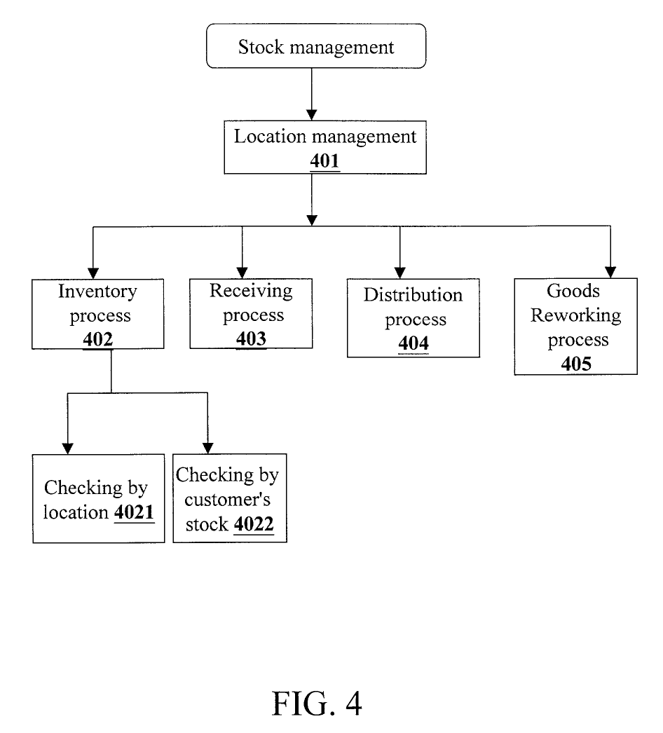

Stock management is the competitive power of a logistics company. The quality of stock management also reflects the quality of the company. FIG. 4 illustrates a schematic block diagram of a stock management unit in a system of the invention. The stock management unit 140 provides storage and location management 401 for goods. The location of goods is designated by a specific location in a specific zone. According to the frequency and quantity of goods moving in and out, the stock is categorized into several storage zones. Each storage zone contains a plurality of storage locations. Each storage location is the basic unit of stock management, in which only one goods of the same batch and same kind can be stored. Each storage location further includes several pallets for carrying certain layers of product according to the unitary weight of the product.

Storage and location management 401 includes an inventory process 402, a receiving process 403, a distribution process 404 and a goods reworking process 405. The inventory process 402 involves checking by location and checking by customer's stock. Inventory checking is based on an inventory list of items and quantities. The result of checking is registered into the system. The receiving and distribution processes 403, 404 are described above. The goods reworking process 405 involves simple packaging, amending or repackaging returned or unpacked products into sellable products according to customer's requirements. The management of the reworking process will be described below.

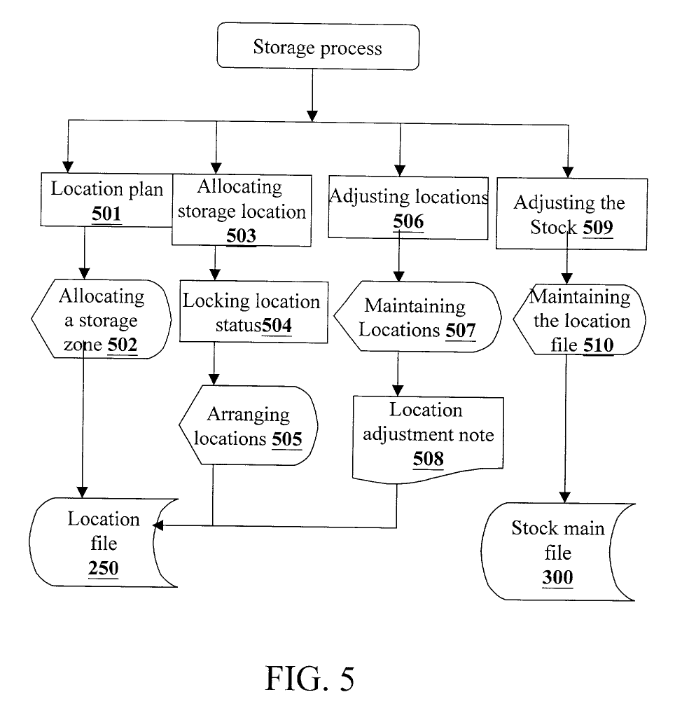

FIG. 5 is a flowchart of the storage process in an embodiment of the invention. The storage process includes the following steps. Provide a location plan (step 501) for allocating a storage zone (step 502) and registering to the location file. Allocate storage locations for receiving and distribution (step 503). Manage the product quantity and lock the location status (step 504). Arrange the locations (step 505) and register to the location file. Adjust the locations (step 506), maintain the locations (step 507), print a location adjustment note (step 508), adjust the stock (step 509), maintain the location file (step 510) and register to the stock main file 300.

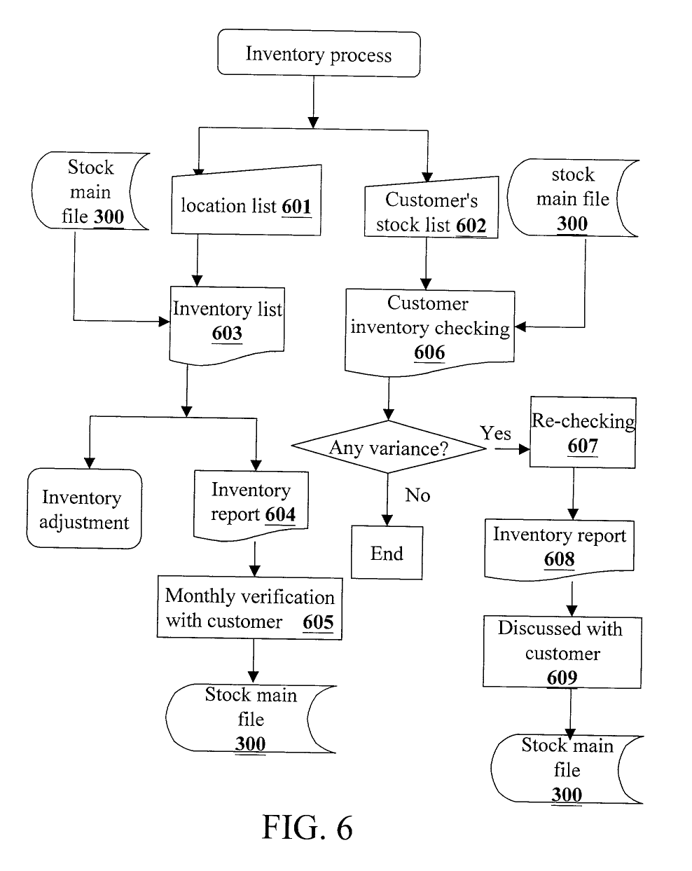

FIG. 6 is a flowchart of inventory checking in an embodiment of the invention. Inventory checking can be executed by a location list 601, by a customer's stock list 602 or by the category of a product. The daily inventory checking is preferably made by a location list 601. The result of inventory checking is registered into the system for generating an inventory list (step 603). By comparing the inventory list with the location file, an inventory report showing the variance can be generated (step 604). The inventory report is sent to the customer monthly for verification or discussion (step 605), and registered to the stock main file 300.

Inventory checking made by the customer's stock list 602 can be executed by the customer at the end of each month (step 606). By checking the item and quantity at each listed location, the actual stock is checked. If the stock differs from the stock list 602, a secondary checking will be made (step 607). The variant result of inventory checking is registered into the system for generating an inventory report (step 608) to be verified and discussed with the customer (step 609). Finally, adjust the location file 250 and the stock main file 300 for correcting the difference.

Reworking Management Unit 150

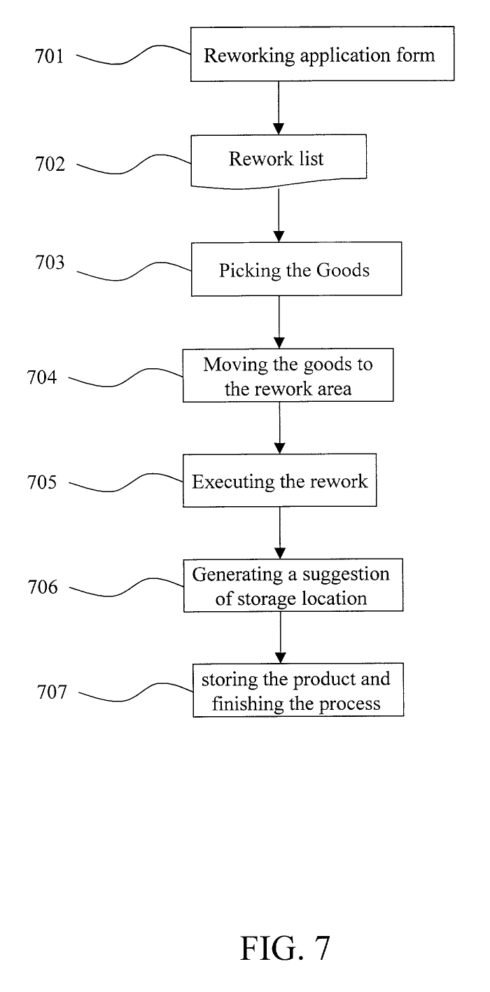

FIG. 7 is a flowchart of reworking management according to the invention. First, initialize a reworking application form (step 701). Generate a rework list (step 702) showing the required items, quantities, locations and other detailed information, name of reworked product, category, working method and so on. Pick the goods according to the rework list (step 703). Move the goods to the rework area (step 704). Execute the rework (step 705), registering the time and cost and reporting to the managing department. The managing department verifies the reworked item, quantity, name and part number in the system in order to generate a suggestion for storage location (step 706). Finally, store the product and complete the reworking process (step 707).

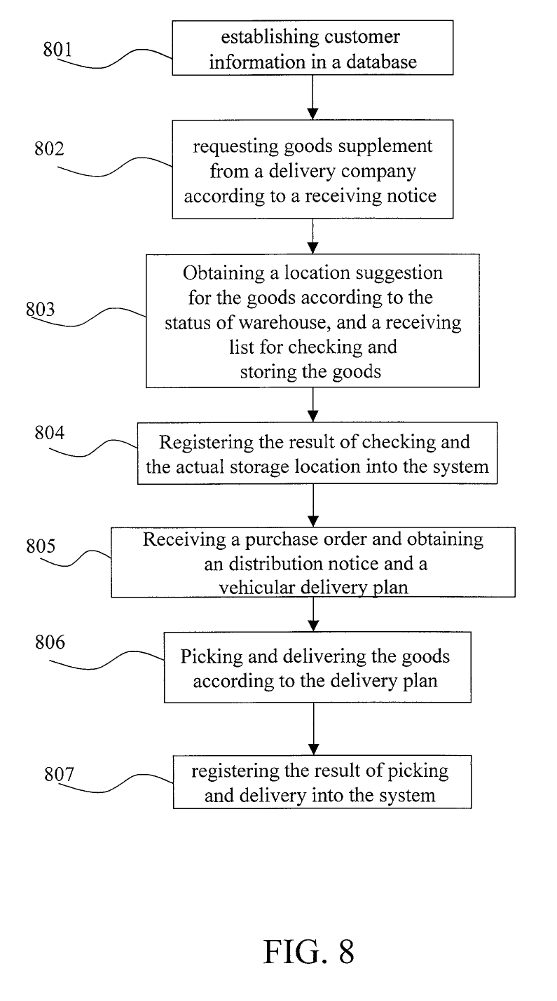

FIG. 8 is a summary flowchart of stock management according the invention. First, establish customer information in a database (step 801). Then request goods supplement from a delivery company according to a receiving notice (step 802). Obtain a location suggestion for the goods according to the status of the stock, and a receiving list for checking and storing the goods (step 803). Register the result of checking and the actual storage location into the system (step 804). Receive a purchase order and obtain a distribution notice and a vehicular delivery plan (step 805). Pick and deliver the goods according to the delivery plan (step 806). Finally, register the result of picking and delivery into the system (step 807) for maintaining the stock file.

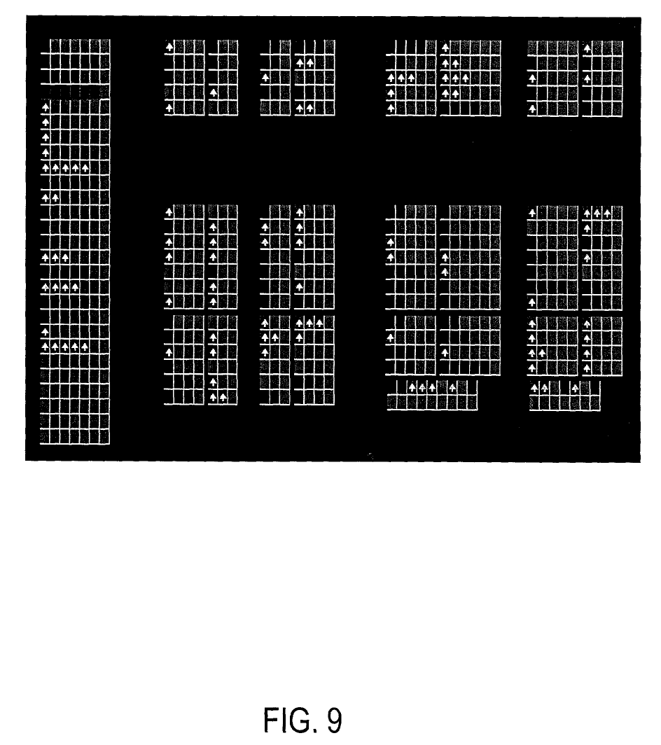

FIG. 9 is an example of a computer graphic interface in an embodiment of the invention. The graphic interface implements the moving and combining of storage locations with reasonable rules for easily modifying and maintaining the database. Icons with different shapes and colors indicate the status of the storage locations.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A computerized stock management system, utilizing a client and sever database architecture, comprising at least:
a customer management unit for recording customer information;
a receiving management unit, connecting to said customer management unit, for processing receiving notice of customer;
a distribution unit, connecting to said customer management unit, for processing distribution notice of customer;
a stock management unit, connecting to said receiving and distribution management systems, for providing storage and location management for goods; and
a reworking management unit, connecting to said stock management unit, for managing product packaging, amendment, reconstruction and forming new products according to customer's requirements.

2. A computerized stock management system according to claim 1 wherein said receiving management unit processes goods supplement according to an inventory report.

3. A computerized stock management system according to claim 2 wherein said goods supplement is processed by handling a receiving notice of a customer and requesting the receiving schedule, item and quantity of goods from a goods delivery company.

4. A computerized stock management system according to claim 2 wherein said goods supplement is further processed by considering the status of stock, obtaining a suggestion of storage location, and a receiving list for checking and storing the goods.

5. A computerized stock management system according to claim 4 wherein said goods supplement is further processed by registering the result of checking and the actual storage location into the system.

6. A computerized stock management system according to claim 1 wherein said distribution management unit processes distribution according to a purchase order obtained selectively from transference and from registration.

7. A computerized stock management system according to claim 1 wherein said distribution management unit processes the purchase order and obtains a distribution list and a shortage list.

8. A computerized stock management system according to claim 7 wherein said distribution management unit further generates a vehicular delivery plan for an optimal delivery in accordance with said distribution list.

9. A computerized stock management system according to claim 8 wherein said distribution management unit further allows manual adjustment to the vehicular delivery plan.

10. A computerized stock management system according to claim 8 wherein said vehicular delivery plan comprises a vehicle plan, a picking list, a distribution list and a route plan.

11. A computerized stock management system according to claim 1 wherein said distribution management unit further provides at least a form selective from summary of receiving and distribution products, monthly and daily income reports, daily stock report and product hierarchy list of the customer, so as to help customers monitoring and managing the goods stored in the stock.

12. A computerized stock management system according to claim 1 wherein said stock management unit utilizes a graphic interface for stock management.

13. A computerized stock management system according to claim 1 wherein said stock management unit utilizes a storage location management.

14. A computerized stock management system according to claim 13 wherein said storage location management comprises management for at least a storage zone, a storage location and a pallet.

15. A computerized stock management system according to claim 13 wherein said storage location management further comprises an inventory checking process, a receiving process, a distribution process and a reworking process.

16. A computerized stock management system according to claim 15 wherein said inventory checking process is selectively executed by a location list and by a customer's stock list.

17. A computerized stock management method, utilizing a client and sever database architecture, and executed through a storage location management manner, comprising at least steps of:
establishing customer information in a database;
receiving goods from a delivery company according to a receiving notice;
generating a location suggestion according to condition of current storage, and producing a goods checklist for checking and locating the goods;
recording the result of checking and the actual storage location into the computer;
receiving a purchase order, providing a distribution report and a delivery plan;
picking and delivering goods according to the delivery plan; and
recording the result of picking and delivery into the computer.

18. A computerized stock management method according to claim 17 further comprises a reworking process for packaging, amending and repackaging products into new products according to customer's requirements.

19. A computerized stock management method according to claim 17 further comprises a process of providing inquiry of receiving.

20. A computerized stock management method according to claim 17 further comprises a goods supplement process executed by handling a receiving notice of a customer and requesting the receiving schedule, item and quantity of goods from a delivery company.

21. A computerized stock management method according to claim 17 wherein said purchase order is obtained selectively from transference and from registration.

22. A computerized stock management method according to claim 17 wherein said distribution report comprises a distribution list and a shortage list.

23. A computerized stock management method according to claim 17 wherein said delivery plan is capable of being manually adjusted.

24. A computerized stock management method according to claim 17 wherein said delivery plan comprises a vehicle plan, a fee rate, a picking list, a distribution list and a route plan.

25. A computerized stock management method according to claim 17 further comprises a process of providing at least a form selective from summary of receiving and distribution products, monthly and daily income reports, daily stock report and product hierarchy list of the customer, so as to help customers monitoring and managing the goods stored in the stock.

26. A computerized stock management method according to claim 17 wherein said storage location management comprises management for at least a storage zone, a storage location and a pallet.

27. A computerized stock management method according to claim 17 wherein said storage location management further comprises an inventory checking process, a receiving process, a distribution process and a reworking process.

28. A computerized stock management method according to claim 27 wherein said inventory checking is selectively executed by storage location, customer's stock and category of product.

29. A computerized stock management method according to claim 17 wherein said storage location management comprises a graphic interface for easily modifying and maintaining the database.
